(19) United States
(12) Patent Application Publication
(10) Pub. No.: US 2012/0036863 A1
(43) Pub. Date: Feb. 16, 2012

(54) METHOD, APPARATUS AND SYSTEM FOR DELIVERY OF WIDE RANGE OF TURBINE FUELS FOR COMBUSTION

(76) Inventors: Joseph Kirzhner, Greenvile, SC (US); Predrag Popovic, Greenville, SC (US); Roy Marshall Washam, Clinton, SC (US)

(21) Appl. No.: 12/856,107

(22) Filed: Aug. 13, 2010

(51) Int. Cl. F02C 7/22; F02C 9/00

(52) U.S. Cl. 60/776; 60/39.281

(57) ABSTRACT

In operating a gas turbine, there can be a difference between the desired heating value of the fuel and the actual needs of the fuel for sustainable combustion during various stages of the turbine operation. In one aspect, combustible lean limit operation of the gas turbine free of lean blow out is enabled by adjusting fuel-air-ratio of the fuel and fuel-air mixture properties, based on the operation requirements of the turbine and flammability of the fuel components.

One or more aspects of the present invention relate to method, apparatus and system for delivery of a wide quality range of turbine fuels for combustion.

### BACKGROUND OF THE INVENTION

In general, gaseous fuels, liquid fuels, or both may be combusted in a gas turbine. In the past, the heating value was used as an indicator of an amount of fuel, which should be provided to the combustor, especially for starting and shutdown to meet the energy requirements. Often, the heating value was used as an indicator of fuel quality—higher heating value usually indicated higher fuel quality.

However, supply of high quality turbine fuels is not always guaranteed. Due to market fluctuations, it is often beneficial for an operator to operate the gas turbine using different types of turbine fuels at different times. In the U.S. Pat. No. 6,640,548 issued to Brushwood et al. (hereinafter “Brushwood”), a method is disclosed to combust low quality fuel in a gas turbine engine. Brushwood discusses measuring the fuel quality in terms of two characteristics—the heat value Q and flammability range. In Brushwood, high quality fuels are those fuels that have Q values above 100 BTU/SCF and flammability ratio RL/LL (rich limit, lean limit) of 2 or more such as natural gas and propane. Examples of low quality fuels, those that have Q values below 100 BTU/SCR or flammability ratio less than 2, include fuels produced by low-grade biomass gasification, by coal gasification or by petroleum coke gasification.

Brushwood discusses that during start up, a high quality fuel H1 is used as a pilot fuel to initiate combustion. Then a flow of high quality fuel H2, which may be from the same source as H1, is initiated and increased until a desired power level is achieved. A flow of low quality fuel L may be initiated only upon reaching the desired power level, and then gradually increased. The flow of low quality fuel, which is presumably cheaper and more plentiful than H1 and H2, is maintained so long as the frame remains stable as indicated by a sensor. If instability is detected, the supply of high quality fuel is increased to avoid flame out. In Brushwood, the high quality fuel is required for start up. The low quality fuel is not used until some level of operation is reached. Also, high quality fuel must be available during operation to avoid flame out.

But as mentioned above, high quality fuels may not always be available. Even when available, the high quality fuel may be prohibitively expensive. Thus, it is desirable to operate a gas turbine that combust a wide quality range of turbine fuels, even during start up and shutdown periods. In addition, it is desirable to be able to operate the gas turbine without requiring high quality fuel always being available.

### BRIEF SUMMARY OF THE INVENTION

A non-limiting aspect of the present invention relates to a method for delivering fuel and air mixture to a gas turbine. The fuel can comprise a composition of one or more fuel components. In the method, a controller may determine a combustible lean limit of the mixture entering a combustor of the gas turbine. The combustibility may be determined based on fuel parameters of the fuel in the mixture, on air parameters of the air in the mixture, or on both. The controller may also determine a desired combustible lean limit of the mixture for operating the gas turbine, and a fuel-to-air ratio of the mixture such that the fuel-to-air ratio of the adjusted mixture is at or above the desired combustible lean limit of the fuel after adjustment. The combustible lean limit of the fuel may be viewed as a flammability limit of the mixture below which a lean blow out will not be prevented.

Another non-limiting aspect of the present invention relates to a controller for controlling delivery of fuel and air mixture to a gas turbine. The fuel can comprise a composition of one or more fuel components. The controller may include a parameter receiving unit, a combustible lean limit determining unit, a desired lean limit determining unit, and an adjusting unit. The parameter receiving unit can be arranged to receive fuel parameters of the fuel in the mixture, air parameters of the air in the mixture, or both. The combustible lean limit determining unit can be arranged to determine a combustible lean limit of the mixture based on the fuel parameters, on the air parameters, or on both. The desired lean limit determining unit arranged to determine a desired combustible lean limit of the mixture for operating the gas turbine. The adjusting unit arranged to adjust a fuel-to-air ratio of the mixture such that the fuel-to-air ratio of the adjusted mixture is at or above the desired combustible lean limit of the fuel after adjustment.

The invention will now be described in greater detail in connection with the drawings identified below.

### BRIEF DESCRIPTION OF THE DRAWINGS

These and other features of the present invention will be better understood through the following detailed description of example embodiments in conjunction with the accompanying drawings, in which:

FIG. 1 illustrates a diagrammatical view of a fuel and air control according to a non-limiting aspect of the present invention;

FIG. 2 illustrates an embodiment of a system for delivering fuel and air mixture to a gas turbine according to a non-limiting aspect of the present invention;

FIG. 3 illustrates an embodiment of a controller arranged to control delivery of fuel and gas mixture to a gas turbine according to a non-limiting aspect of the present invention;

FIG. 4 illustrates a flow chart of an example method for delivering fuel and air mixture to a gas turbine according to a non-limiting aspect of the present invention;

FIG. 5 is a diagram illustrating examples of flammability limits for various fuels, and flammability limits application to determine lean blow out values for specific combustor and various combustor operating conditions; and

FIG. 6 is a diagram that illustrates an example relationship between combustibility lean limits vs. calorific values and temperatures for various fuels.

### DETAILED DESCRIPTION OF THE INVENTION

A novel method, system, and apparatus for delivering fuel and air mixture to a gas turbine are described. The described method, system, and apparatus utilize fuel and air mixture combustibility corrections to obtain stable combustor operation including operation during startup period of the gas turbine.

As mentioned above, it is desirable to be able to operate a gas turbine that can combust a wide quality range of turbine fuels during all periods of the turbine operation including startup and shutdown periods. Also as mentioned, heating value is often used as an indicator of the fuel quality. The heating value is an indication of an energy content of the fuel.

When a certain quantity of fuel reacts with oxygen to form water, and other products, a fixed amount of energy is liberated, which is quantified by the fuel's higher heating value (HHV) and lower heating value (LHV). The difference between the two is the heat of vaporization and represents an amount of energy required to vaporize liquid water into gaseous state. Both HHV and LLV are expressed as an amount of energy (Joules, BTUs) for a given weight of fuel.

LHV will be primarily used to describe the examples to demonstrate some of the beneficial features of various aspects of the present invention. However, it should be noted that the present invention is not so limited, and the principles of the invention will be applicable even when the energy are considered in terms of HHV or Q or other similar expressions.

There can be a difference between the desired heating value for a turbine, which may be needed to obtain energy for ignition and stable starting period, and the actual needs for the supplied fuel to be ignited and to sustain flame propagation during various stages of the turbine starting period. Actual needs for reliable ignition and sustainable flame can be more accurately estimated with an evaluation of another fuel property—the fuel's flammability, also referred to as combustibility. Generally, if the flammability is too low, no ignition and stable combustion will be reached. If the flammability is too high, risk of explosion and high emissions will increase.

For a fire or explosion to occur, fuel, oxygen and an ignition source are required. Also, the fuel and oxygen must be mixed in appropriate quantities. The flammability of a fuel is typically defined in terms of its lower and upper flammability limits (LFL, UFL). The LFL and UFL are respectively, the lowest and highest gas concentration of the fuel relative to air that will support a self-propagating flame when ignited. Below the LFL, the fuel/air mixture is too lean for combustion, i.e. there is not enough fuel. Above the UFL, the mixture is too rich, i.e. there is not enough air.

It is desirable to maintain lean burn operation to reduce NOx emissions. Thus it is desirable to operate the gas turbine with as lean mixture as possible. However, the mixture should not be so lean so that a lean blow off (LBO) occurs. As it relates to gas turbines, LBO is a condition in which the flow of fuel is insufficient to maintain combustion. LBO is proportional to LFL, and approaches LFL as velocity approaches zero.

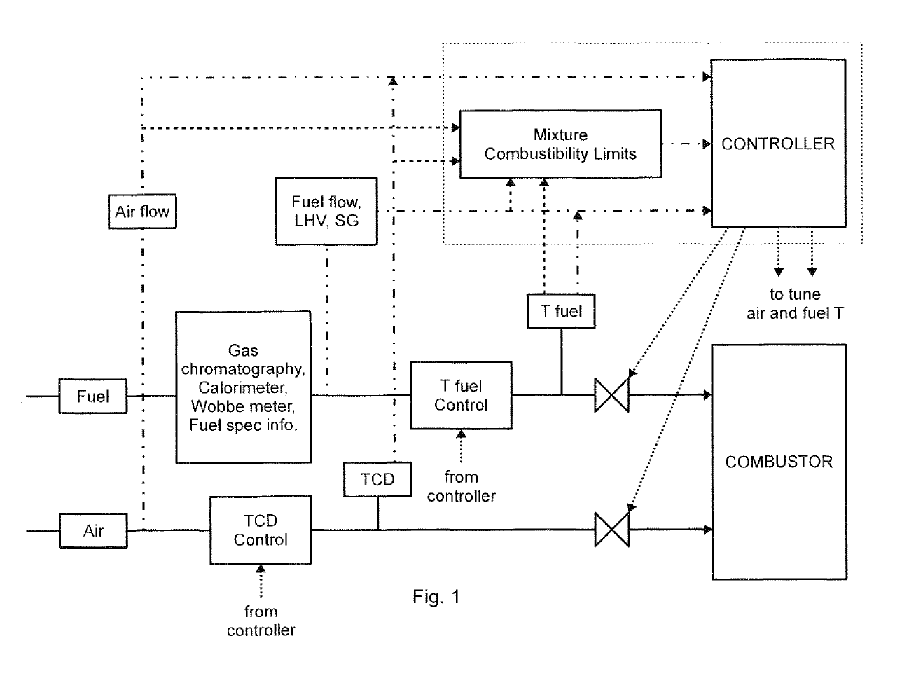

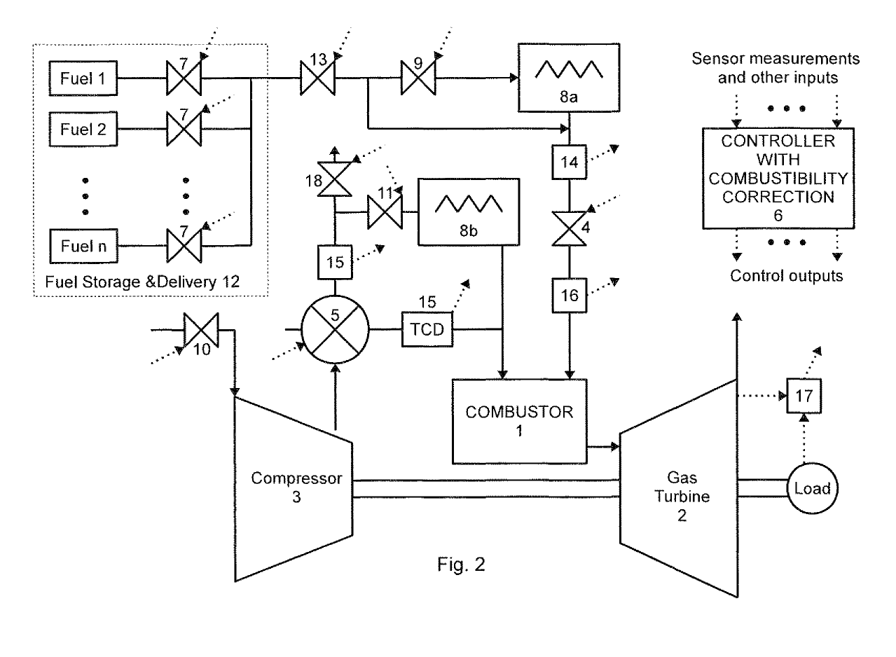

FIG. 1 a simplified view of a fuel and air control diagram and FIG. 2 is an example system that adjusts fuel and air delivery to a combustor of a gas turbine to maintain combustion, for example, to obtain safe and stable ignition, warm up and acceleration during a start up the gas turbine. While the start up period will be described in detail for explanation purposes, it should be noted that the adjustment of fuel and air delivery also applies other operation periods such during load conditions and the shut down of the turbine.

As seen in FIGS. 1 and 2, the system includes a combustor 1 arranged to generate high energy gases to drive a gas turbine 2. A compressor 3 is arranged to provide air to the combustor 1, and a fuel valve 4 is arranged to control the amount of fuel delivered to combustor 1. In one non-limiting aspect, the fuel-to-air (F/A) ratio is controlled through controlling the amount of air produced by the compressor 3 and adjusting mechanisms such as the compressor's inlet guide vanes (IGVs), inlet bleed valves, and combustor bypass valves among others. In FIG. 2, an IGV 10 is illustrated.

While the compressed air may be provided directly to the combustor 1, it is preferable that the system includes a three-way valve 5 arranged to control any combination of an amount, pressure, and temperature of air coming to the combustor 1, an amount, pressure, and temperature of returning air to an inlet of the compressor 3, and an amount of air bypassing the combustor 1. An Air Temperature Compressor Discharge (TCD) sensor 15 can be used to estimate temperature of air, temperature of air-fuel mixture, and to calculate air-fuel mixture flammability.

The system includes a turbine controller 6. In a non-limiting aspect, the turbine controller 6 controls both the air and the fuel delivery based on fuel flammability correction model, which will be described in more detail below. Also as will be described in further detail below, the controller 6 may receive measurements from various sensors and other fuel specification values as inputs, and will generate as outputs control information to control the operation of the gas turbine 2. To minimize clutter, signals to and from the controller 6 are represented as dashed arrows in FIG. 2.

In a non-limiting aspect of the present invention, the controller 6 is arranged to control the F/A ratio of fuel and air supplied to the combustor 1 based on the fuel's flammability. The flammability of the fuel may be determined using the specification for each given fuel. The flammability may also be determined using a fuel composition measurement, for example, through a fuel composition sensor 16.

An example of the fuel composition sensor is a gas chromatography device, calorimeter, or Wobbe meter sensor. The fuel composition sensor 16 such as the gas chromatography device is arranged to detect the fuel composition, i.e., can detect the individual components that make up the fuel. Once the fuel composition is determined, the controller 6 can determine the fuel indices corresponding to the fuel components and determine the flammability of the fuel composition as a result. The Wobbe meter sensor is arranged to measure the Wobbe index of the fuel composition. The controller 6 can convert the Wobbe indices of the fuel components into corresponding flammability indices and determine the flammability of the fuel. The calorimeter is arranged to detect the heat values of the fuel components, which the controller can then use to convert into flammability indices and then determine the flammability.

Preferably, the system further includes a fuel storage and delivery system 12 arranged to store and/or deliver multiple component fuels in a wide range of quality. The quality of the component fuels may be estimated based on the characteristics or parameters of the component fuels such as heat value, reactivity and flammability just to name a few. In a non-limiting aspect, the controller 6 controls the delivery of each component fuel by adjusting the openings of valves 7 corresponding to the different component fuels. In other words, the controller 6 also determines the composition of the fuel delivered to the combustor 1 by controlling the blending of the component fuels when multiple component fuels are available.

Optionally, a valve 13 may be included which affects the total quantity of the fuel delivered. When included, the controller 6 may control the valve 13 to control the fuel flow. Note that the fuel flow can also be controlled through controlling the valves 7 corresponding to individual fuel components.

To maintain the fuel flammability at a desired value or within a desired range of values, it is preferred that the system also includes a fuel heat exchanger 8a to which at least of a part of the fuel is diverted under the control of the controller 6. For example, the controller 6 may control a valve 9 to control the amount of fuel diverted to the fuel heat exchanger 8a. The fuel temperature may be measured by a fuel temperature sensor 14, which provides the measurements to the controller 6.

As an example, measurements from the fuel temperature sensor 14 may indicate that the fuel temperature is below a designed fuel operation temperature, e.g., when the gas turbine 2 is operating under load. In this instance, the controller 6 may determine that additional fuel flow is necessary to compensate for the lower fuel temperature so as to maintain the flammability at or above the desired combustible lean limit, preferably closer to the lean limit as much as possible.

It may be said that in general, the fuel-to-air ratio of the fuel mixture may be adjusted by adjusting any one or more of the following: adjusting the fuel flow, fuel temperature, and the fuel composition based on the desired combustible lean limit. These adjustments may be viewed as examples of controlling fuel delivery to adjust the fuel-to-air ratio of the mixture. It may also be said that the fuel-to-air ratio of the fuel mixture may be adjusted by controlling air delivery based on the desired combustible lean limit, e.g. by adjusting any one or more of air flow, air temperature, and air pressure.

As mentioned above, the controller 6 can control the operation of the three-way valve 5 to adjust the air flow, pressure and temperature by controlling the amount of air coming to the combustor 1, the amount of returning air to an inlet of the compressor 3, the amount of air bypassing the combustor 1 and so on. The controller 6 can adjust the air pressure by controlling delivery of compressed air from the compressor 3 to the combustor 1.

To adjust the air temperature, the controller 6 may divert at least a part of the air entering the combustor 1 to an air heat exchanger 8b through controlling a valve 11 to preheat the diverted air prior to entering the combustor 1. The air temperature may be measured by an air temperature sensor 15, such as the air temperature compressor discharge sensor, and provided to the controller 6. Note that further air temperature control can also be realized, through an effect known as the inlet bleed heating, by sending at least a part of the compressed air to the compressor inlet via the three-way valve 5. It should also be noted that the fuel and air heat exchangers 8a and 8b can be combined in one module or be provided as separate modules.

Combustibility corrections, i.e. fuel-to-air ratio of the fuel and air mixture can be adjusted, based on other than fuel related measurements. For example, the system preferably includes one or more flame sensors 16, which measure parameters related to a flame in the combustor 1. Such parameters include combustion pressure fluctuations, and/or could be optical, or any other parameter, used in industry for flame characterization. The controller 6 may use these measurements to further adjust the fuel-to-air ratio, by controlling fuel delivery and/or air delivery so as to maintain stable combustion throughout various operation periods and stages of the gas turbine 2.

As another example, the acceleration of the gas turbine rotor may be taken into account when adjusting the fuel-to-air ratio. A rotor speed sensor 17 may measure the speed of the rotor. The controller 6 may use the rotor speed measurement to determine the rotor's acceleration and adjust the fuel-to-air ratio accordingly. Note that load, the temperature, and emissions from the gas turbine 2 may also be measured and provided as inputs to the controller 6.

In the system illustrated in FIGS. 1 and 2, it is seen that the fuel can be a composition of one or several individual fuel components, and the delivery of each fuel component can be controlled by opening and closing the valves 7 corresponding to each fuel component. Each component fuel may have different characteristics or parameters such as heat values, specific gravity, flash point, and so on.

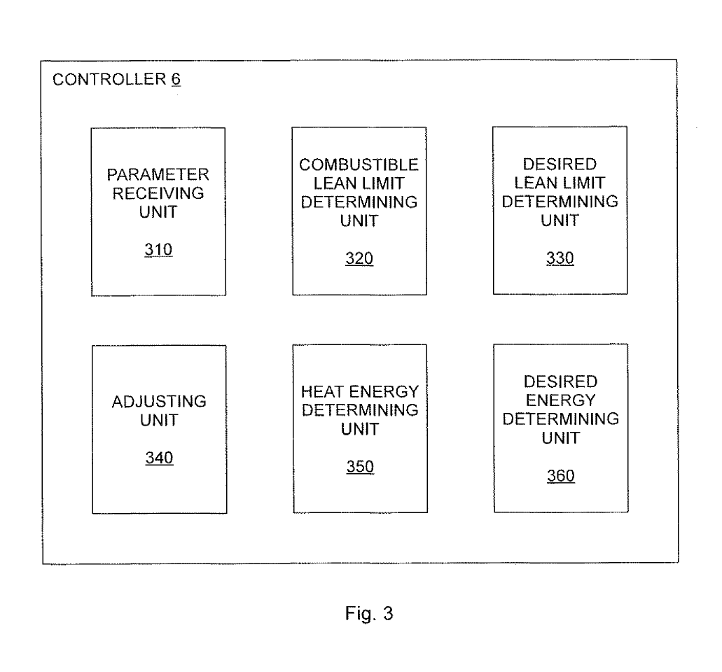

Also in FIGS. 1 and 2, it is seen that the controller 6 plays an important role in controlling the delivery of fuel and air mixture to the gas turbine 2. FIG. 3 illustrates an embodiment of the controller 6 according to a non-limiting aspect of the present invention. The controller 6 can include a parameter receiving unit 310, a combustible lean limit determining unit 320, a desired lean limit determining unit 330, and an adjusting unit 340. The controller 6 may also include a heat energy determining unit 350 and a desired energy determining unit 360.

Note that FIG. 3 provides a logical view of the controller 6 and the units included therein. That is to say, it is not strictly necessary that each unit be implemented as a physically separate module. Some or all units may be combined in a physical module. For example, the combustible lean limit determining unit 320 and the desired lean limit determining unit 330 may be combined in a single module. Moreover, the units need not be implemented in hardware strictly. It is envisioned that the units are implemented through a combination of hardware and software. For example, the actual controller 6 may include one or more central processing units executing non-transitory program instructions stored in a storage medium or in firmware to perform the functions of the units illustrated in FIG. 3.

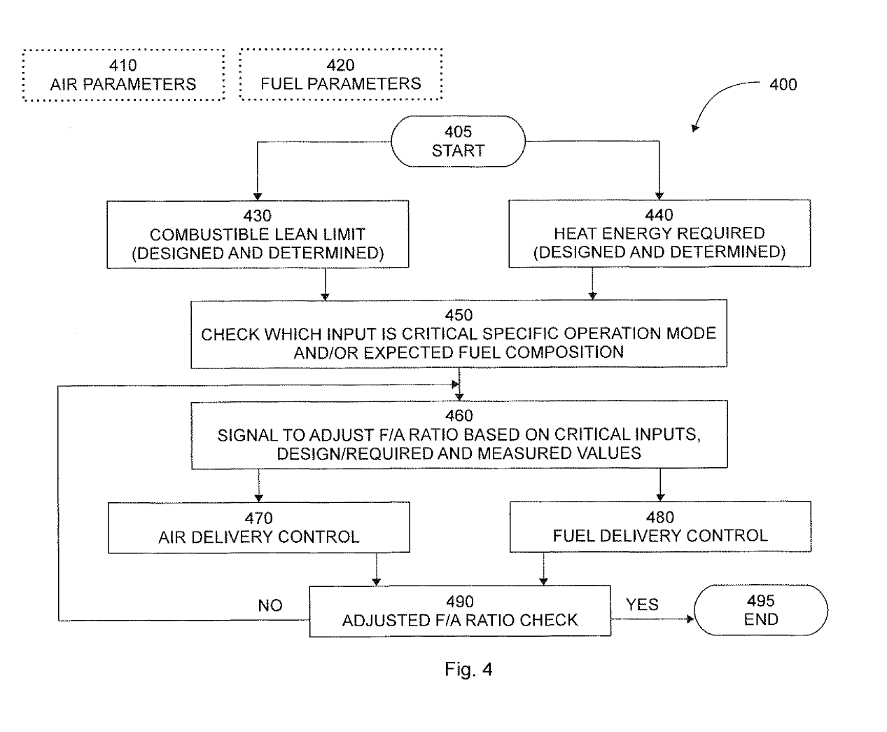

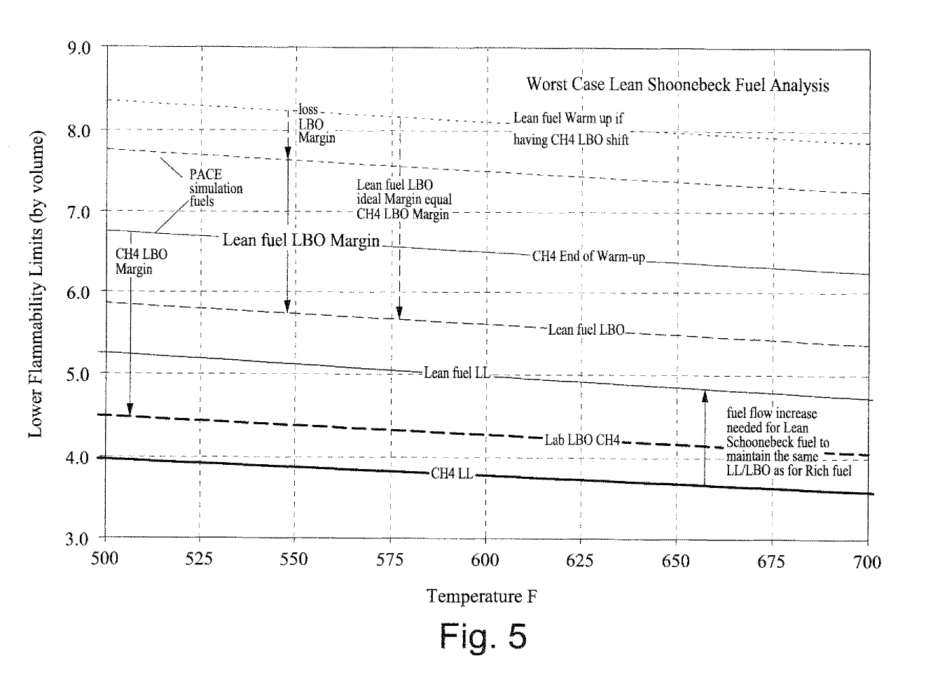

The roles each unit of the controller 6 plays will be described in conjunction with FIG. 4 which illustrates a flow chart of an example method for delivering fuel and air mixture to the gas turbine 2 according to a non-limiting aspect of the present invention. Generally in the method, the fuel and air parameters are used to obtain and maintain stable combustion. Based on the parameters, a proper fuel-to-air (F/A) ratio that will prevent lean blow out (LBO) is estimated or otherwise determined. Such adjustment is advantageous since different fuels can have different flammability limits as seen in FIG. 5.

Note that the F/A ratio determination can be dynamic, i.e. it can be performed continuously to adapt to changing circumstances such as a change in the component fuels or change in the operating conditions of the gas turbine among others.

Preferably, a minimum F/A ratio—also referred to as combustible lean limit or lower flammability limit (LFL)—of the fuel and air mixture is determined. Maintaining the combustible lean limit has the additional benefit of reducing NOx, CO, and HC emissions. Because the F/A ratio, the temperature of the mixture, or both are determined to arrive at a desired flammability, marginally above the combustible lean limit, the method in one non-limiting aspect can be referred to as fuel lean limit flammability correction model.

Referring back to FIGS. 1 and 2 and previously mentioned, the controller 6 can control any one or more of the valves of the system taking into account the fuel's heat value and fuel+combustion air mixture properties. For example, if the temperature of the air is lower than the turbine combustor design air temperature, the fuel valve 4 can be opened additionally (to what calculated, taking into account the fuel's heat value and consumption) to maintain the same combustible lean limit and LBO margin. Another way is to adjust when the air temperature is low is to increase the temperature of the fuel, air, or both with the use of the heat exchangers 8a and/or 8b. Of course, both adjustments of increasing the amount of fuel flow (by additionally opening the valve 4) and increasing the temperature of the fuel/air mixture (using heat exchangers 8a, 8b) can be simultaneously applied to maintain the LBO margin and the combustible lean limit.

In one aspect, the following lean limit equation (1) is used to make adjustments to maintain the combustible lean limit (LL).

LL=k(aLHV²−bLHV+c) (1)

where k represents the temperature correction coefficient and a, b, and c represent polynomial correction coefficients.

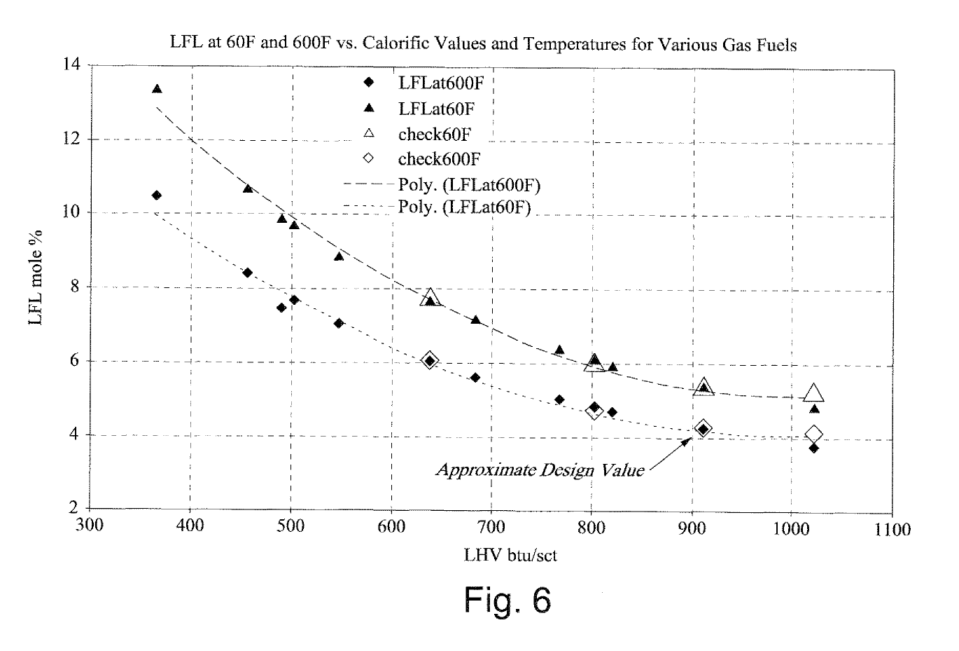

Equation (1) may be viewed as a transfer function that describes or models a relationship between the fuel temperature, the fuel's LHV value, and the lean limit. FIG. 6 is a diagram that illustrates an example relationship of the combustibility lean limits vs. calorific values and temperatures for various gas fuels. Equation (1) and FIG. 6 demonstrate that the combustibility correction can be made based on the heating values of the fuel, and the temperature of the fuel and air blend.

Note that equation (1) models the transfer function as a second order polynomial. But it should be noted that the invention is not so limited. Higher order polynomials, and even a linear model is fully contemplated. However, in many instances, the second order polynomial of equation (1) provides good enough results.

The method 400 illustrated in FIG. 4 is applicable to all operation periods of the gas turbine. For explanation purposes however, the method will be described in detail as it relates to the stages of the gas turbine's start up period including cranking, purge, fuel and air delivery, ignition, acceleration, and warm up stages. As seen in step 410 in the upper left of FIG. 4, the parameters related to the air entering the combustor can be received by the parameter receiving unit, for example one or more air parameter sensors may provide some or all of the parameters. Some of the parameters may be preloaded based on specifications provided by vendors. The air related parameters include any one or more of air flow, pressure, and temperature.

In step 420, the parameter receiving unit may receive one or more parameters related to the fuel entering the combustor. Also, one or more fuel parameters may be preloaded. The fuel related parameters include fuel flow, fuel composition, heat value, temperature, and specific gravity.

As mentioned, the fuel and/or air parameters provided to the parameter receiving unit can be measured by sensors. For example, the fuel's energy content may be determined based on measurements provided by a gas chromatography device or a calorimeter. As another example, a Wobbe meter may measure the Wobbe index (WI), which is an index related to the heating value of the fuel. As an alternative or in addition to, the parameters may also be inputted based on specifications provided by fuel suppliers and vendors. For example, a natural gas supplier can provide information such as the fuel's composition, LHV and WI.

Steps 410 and 420 are shown as dashed boxes and without connection to other steps to indicate these steps may be performed continuously. That is, the parameters of the fuel and air entering the combustor can be continuously monitored and updated.

During the stages of the start up period (as well as other periods), parameters are provided to the controller 6 through measurements, vendor specifications or both as seen in steps 410 and 420. In step 405, the method 400 is started. In step 430, the combustible lean limit of the fuel and air mixture entering the combustor are measured or otherwise determined by the combustible lean limit determining unit. In the same step, the desired combustible lean limit is determined by the desired lean limit determining unit. In step 440, the heat energy determining unit and the desired energy determining unit respectively determine the heat energy of the fuel and air mixture and the desired energy for operating the gas turbine.

Note that in steps 430 and 440, the combustibility lean limit determining unit, the desired lean limit determining unit, the heat energy determining unit and the desired energy determining unit takes into account the operation period—startup, load, and shutdown periods—of the gas turbine. Even within each operation period, the lean limit determination can vary depending on the operation mode of the period. For example, in the startup period, the operation mode can be in any of cranking, purge, fuel and air delivery, ignition, acceleration, and warm up stages.

The results from steps 430 and 440 are provided as inputs to the adjusting unit, for example, at the start of any operation mode of the gas turbine start up period in step 450. In this step, the adjusting unit determines the desired flammability of the fuel and air mixture for the operation mode based on the information gathered in steps 430 and 440, and determines which input or inputs are critical for the specific operation mode, the expected fuel composition or both. In this context, “critical” indicates that there is significant difference between the measured value and the design value of a parameter. For example, the fuel's LHV may be too low, and fuel-air mixture temperature already high. In this instance, the fuel blending can be adjusted, by opening valve 7 corresponding to a more reactive fuel component to bring the fuel's LHV to the designed value or to within a designed range of values. In this example, the more reactive fuel component is a critical input since it affects whether or not the fuel's actual LHV will be as designed. Since a parameter may be affected by multiple factors, there can also be multiple critical inputs. In the above-example, any fuel component that has high enough LHV can be used to increase the LHV of the total fuel, and thus be considered critical.

Based on the critical inputs, the adjusting unit in step 460 adjusts the F/A ratio by controlling any of the facets related to the fuel and its delivery to bring the turbine operation within designed values. These facets include controlling, among others, the air delivery in step 470 and fuel delivery in step 480. Referring back to FIGS. 1 and 2, it is seen that the fuel delivery can be controlled by controlling any one or more of the fuel flow, component fuel composition, and the fuel temperature by controlling any one or more of the valves 4, 7, 9 and 13. The air delivery can be controlled by controlling any one or more of the air flow, the air pressure, and the air temperature through operating the valves 5, 10 and 11.

In step 490, the adjusting unit determines whether the desired F/A ratio adjustment has been made. For example, feedback information from one or more sensors can be used to make the determination. If the desired adjustment has not been made, then the steps 460, 470, 480 and 490 can be repeated.

In a non-limiting embodiment, the types of feedback provided through the sensors include any one or more of the fuel composition, fuel flow, fuel temperature, energy content, specific gravity, air flow, air temperature, and air pressure among others.

Note that the desired F/A ratio can be particular to the fuel delivered to the combustor and to the operation mode of the gas turbine. It is common knowledge that different fuels have different flammability limits at a given temperature and pressure. For example, the desired F/A ratio of hydrogen at the warm up stage may be different from the desired F/A ratio of methane at the same warm up stage. It is also common knowledge that for a given fuel, the flammability limits can change as the temperature changes. Thus, the desired F/A ratio of hydrogen at the ignition stage may be different from the desired F/A ratio of hydrogen at the warm up stage or the acceleration stage. When there are multiple component fuels making up the composition of the fuel delivered to the combustor, the desired F/A ratio may also change based on the particular blending of the component fuels as well, that is, the F/A ratio can be based on the fuel composition. Thus, feedback information regarding the fuel composition would be useful.

It is not strictly necessary to arrive at the desired F/A ratio when performing the steps to adjust the F/A ratio. Thus, in a non-limiting implementation of the step 490 to determine whether or not the desired F/A adjustment has been made, the criteria may be satisfied when the difference between the desired F/A ratio and the adjusted F/A ratio is close enough, i.e., the difference is within a predetermined value. Of course, the adjusted F/A ratio should not be below the combustible lean limit of the mixture.

As an alternative, the desired F/A ratio range may be specified. In this instance, the criteria for determining whether or not the desired F/A adjustment has been made can be satisfied when the adjusted F/A ratio value falls within the specified range. The desired F/A ratio range can include the combustible lean limit but should not include values that fall below the combustible lean limit. If some margin of error is desirable, then the lower limit of the desired range can be some predetermined value above the combustible lean limit.

Note that combustibility lean limit affects the minimum fuel setting. If any less fuel is provided, lean blow out will occur. However, a maximum fuel setting should also be determined so that a risk of explosion is minimized. The maximum fuel setting can be determined based on a companion combustible rich limit correction. In one aspect, the adjusting unit of the controller may determine the minimum and maximum fuel settings respectively with combustible lean limits correction and combustible rich limits correction when the gas turbine is in the acceleration mode of the startup period.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for delivering fuel and air mixture to a gas turbine, wherein the fuel comprises a composition of one or more fuel components, the method comprising:
a controller determining a combustible lean limit of the mixture entering a combustor of the gas turbine based on fuel parameters of the fuel in the mixture, on air parameters of the air in the mixture, or on both;
the controller determining a desired combustible lean limit of the mixture for operating the gas turbine; and
the controller adjusting fuel-to-air ratio of the mixture such that the fuel-to-air ratio of the adjusted mixture is at or above the desired combustible lean limit of the fuel after adjustment,
wherein the combustible lean limit of the fuel is a flammability limit of the mixture below which a lean blow out will not be prevented.

2. The method of claim 1, wherein the step of determining the combustible lean limit of the mixture comprises the controller determining the combustible lean limit taking into account an operation period of the gas turbine, the operation period being one of startup, load, and shutdown periods.

3. The method of claim 2, wherein when the operation period is the startup period, the step of determining the combustible lean limit of the mixture comprises the controller determining the combustible lean limit taking into account an operation mode of the startup period of the gas turbine, the operation mode being one of cranking, purge, fuel and air delivery, ignition, acceleration, and warm up stages of the start up period.

4. The method of claim 1, further comprising:
the controller determining heat energy of the mixture; and
the controller determining a desired heat energy for operating the gas turbine,
wherein the step of adjusting the fuel-to-air ratio of the mixture comprises adjusting the fuel-to-air ratio such that the desired heat energy is met.

5. The method of claim 1, wherein the step of adjusting the fuel-to-air ratio of the mixture comprises:
the controller determining one or more critical inputs for an operation mode, an expected fuel composition, or both based on parameters of the fuel parameters, air parameters, or both; and
the controller controlling air delivery or fuel delivery or both based on the critical inputs and the combustible lean limit of the mixture so as to achieve a desired fuel-to-air ratio,
wherein each critical input correspond to an input that affects a fuel parameter or an air parameter that is outside of a desired value or desired range of values so that the fuel parameter or the air parameter is brought to the desired value or within the desired range of values.

6. The method of claim 1, wherein in the step of adjusting the fuel-to-air ratio of the mixture, the fuel-to-air ratio is adjusted so that the flammability of the fuel after adjustment is within a range defined by the desired combustible lean limit plus a predetermined lean blow off margin.

7. The method of claim 1, wherein the step of adjusting the fuel-to-air ratio of the mixture comprises the controller applying a combustibility correction based on a transfer function that models a relationship between a fuel temperature, the fuel's heating value, and the combustibility lean limit of the fuel.

8. The method of claim 7, wherein the transfer function is expressed as LL=k(aLHV²−bLHV+c), in which LL represents the combustible lean limit, LHV represents a lower heating value of the fuel, k represents a temperature correction coefficient, and a, b, and c represent polynomial correction coefficients.

9. The method of claim 1, wherein the step of determining the combustible lean limit of the mixture comprises:
the controller determining the fuel parameters based on measurements from fuel parameter sensors or based on parameters provided as inputs from fuel specification values or both;
the controller determining the air parameters based on measurements from air parameters sensors; and
the controller determining the combustible lean limits based on the fuel and air parameters, wherein
the fuel parameters includes any one or more of fuel flow, fuel temperature, specific gravity of each fuel component, heating value of each fuel component, Wobbe index of each fuel component, and fuel flammability index of each fuel component, and
the air parameters includes any one or more of air flow, air pressure, and air temperature.

10. The method of claim 1, wherein the step of adjusting the fuel-to-air ratio of the mixture comprises the controller adjusting any one or more of fuel flow, fuel temperature, and fuel composition based on the desired combustible lean limit.

11. The method of claim 10,
wherein adjusting the fuel flow comprises the controller controlling a total amount of fuel entering the combustor through controlling flows of one or more fuel components or through controlling the flow of the fuel in total or both;
wherein adjusting the fuel temperature comprises the controller diverting at least a part of the fuel to a heat exchanger prior to the fuel part entering the combustor based on measurements from a fuel temperature sensor, and
wherein adjusting the fuel composition comprises the controller controlling a blend of the fuel components of the fuel entering the combustor based on measurements from a fuel composition sensor through controlling the flows of one or more fuel components.

12. The method of claim 11,
wherein in the step of adjusting the fuel composition, the blend of the fuel components is determined based flammability indices of one or more individual fuel components,
wherein the fuel composition sensor is a gas chromatography device, a Wobbe meter, or a calorimeter, and
wherein the flammability indices of the fuel components are determined based on measurements from the gas chromatography device, determined by converting Wobbe indices of the fuel components measured by the Wobbe meter, or determined by converting heat values of the fuel components measured by the calorimeter.

13. The method of claim 10, wherein the step of adjusting the fuel-to-air ratio of the mixture further comprises:
the controller determining the fuel flow necessary maintain the flammability limit of the mixture at or above the desired combustible lean limit at a designed fuel operation temperature;
a fuel temperature sensor measuring the fuel temperature of the fuel; and
the controller determining when the fuel temperature is below the designed fuel operation temperature, an amount of additional fuel flow necessary to compensate for the lower temperature of the fuel so as to maintain the flammability at or above the desired combustible lean limit.

14. The method of claim 1, wherein the step of adjusting the fuel-to-air ratio of the mixture comprises the controller adjusting any one or more of air flow, air temperature, and air pressure based on the desired combustible lean limit.

15. The method of claim 14,
wherein adjusting the air flow comprises the controller controlling a total amount of air entering the combustor through controlling one or more of an amount of air entering the combustor, an amount of returning air to an inlet of an air compressor, and an amount of air bypassing the combustor,
wherein adjusting the air temperature comprises the controller diverting at least a part of the air to a heat exchanger prior to the air part or entering the combustor based on measurements from an air temperature sensor, and
wherein adjusting the air pressure comprises the controller controlling delivery of compressed air from the compressor to the combustor.

16. The method of claim 1, further comprising:
one or more flame sensors measuring one or more flame parameters of the flame in the combustor,
wherein the step of adjusting the fuel-to-air ratio of the mixture entering the combustor further comprises the controller adjusting the fuel-to-air ratio of the mixture entering the combustor based on measured parameters of the flame sensor.

17. The method of claim 3, further comprising the controller determining, when the gas turbine is in the acceleration mode of the gas turbine start up period, determining a minimum fuel setting with combustible lean limits correction and determining a maximum fuel setting with combustible rich limits correction.

18. The method of claim 1, further comprising:
a rotor speed sensor measuring a rotor speed of a rotor of the gas turbine; and
the controller determining an acceleration of the rotor based on the rotor speed,
wherein the step of adjusting the fuel-to-air ratio of the mixture further comprises the controller adjusting the fuel-to-air ratio of the mixture based on one or both of an amount of acceleration of the rotor and a comparison between lower heating value, flammability index of the fuel, and lean blow out of combustor flame.

19. A controller for controlling delivery of fuel and air mixture to a gas turbine, wherein the fuel comprises a composition of one or more fuel components, the controller comprising:
a parameter receiving unit arranged to receive fuel parameters of the fuel in the mixture, air parameters of the air in the mixture, or both;
a combustible lean limit determining unit arranged to determine a combustible lean limit of the mixture based on the fuel parameters, on the air parameters, or on both;
a desired lean limit determining unit arranged to determine a desired combustible lean limit of the mixture for operating the gas turbine; and
an adjusting unit arranged to adjust a fuel-to-air ratio of the mixture such that the fuel-to-air ratio of the adjusted mixture is at or above the desired combustible lean limit of the fuel after adjustment,
wherein the combustible lean limit of the fuel is a flammability limit of the mixture below which a lean blow out will not be prevented.

20. The controller of claim 19, wherein the combustible lean limit determining unit determines the combustible lean limit by taking into account an operation period of the gas turbine, the operation period being one of startup, load, and shutdown periods.

21. The controller of claim 20, wherein when the operation period is the startup period, the combustible lean limit determining unit determines the combustible lean limit of the mixture taking into account an operation mode of the startup period of the gas turbine, the operation mode being one of cranking, purge, fuel and air delivery, ignition, acceleration, and warm up stages of the start up period.

22. The controller of claim 19, further comprising:
a heat energy determining unit arranged to determine heat energy of the mixture; and
a desired energy determining unit arranged to determine a desired heat energy for operating the gas turbine,
wherein the adjusting unit adjusts the fuel-to-air ratio of the mixture such that the desired heat energy is met.

23. The controller of claim 19, wherein the adjusting unit adjusts the fuel-to-air ratio of the mixture by:
determining one or more critical inputs for an operation mode, an expected fuel composition, or both based on parameters of the fuel parameters, air parameters, or both, and
controlling air delivery or fuel delivery or both based on the critical inputs and the combustible lean limit of the mixture so as to achieve a desired fuel-to-air ratio,
wherein each critical input correspond to an input that affects a fuel parameter or an air parameter that is outside of a desired value or desired range of values so that the fuel parameter or the air parameter is brought to the desired value or within the desired range of values.

24. The controller of claim 19, wherein in the adjusting unit adjusts the fuel-to-air ratio of the mixture so that the flammability of the fuel after adjustment is within a range defined by the desired combustible lean limit plus a predetermined lean blow off margin.

25. The controller of claim 19, wherein the adjusting unit adjusts the fuel-to-air ratio of the mixture by applying a combustibility correction based on a transfer function that models a relationship between a fuel temperature, the fuel's heating value, and the combustibility lean limit of the fuel.

26. The controller of claim 25, wherein the transfer function is expressed as LL=k(aLHV²−bLHV+c), in which LL represents the combustible lean limit, LHV represents a lower heating value of the fuel, k represents a temperature correction coefficient, and a, b, and c represent polynomial correction coefficients.

27. The controller of claim 19, wherein the combustible lean limit determining unit determines the combustible lean limit of the mixture by:
determining the fuel parameters based on measurements from fuel parameter sensors or through parameters provided as inputs from fuel specification values or both,
determining the air parameters based on measurements from air parameters sensors, and
determining the combustible lean limits based on the fuel and air parameters, wherein
the fuel parameters includes any one or more of fuel flow, fuel temperature, specific gravity of each fuel component, heating value of each fuel component, Wobbe index of each fuel component, and fuel flammability index of each fuel component, and
the air parameters includes any one or more of air flow, air pressure, and air temperature.

28. The controller of claim 19, wherein the adjusting unit adjusts the fuel-to-air ratio of the mixture by adjusting any one or more of fuel flow, fuel temperature, and fuel composition based on the desired combustible lean limit.

29. The controller of claim 28,
wherein the adjusting unit adjusts the fuel flow by controlling a total amount of fuel entering the combustor through controlling flows of one or more fuel components or through controlling the flow of the fuel in total or both;
wherein the adjusting unit adjusts the fuel temperature by diverting at least a part of the fuel to a heat exchanger prior to the fuel part entering the combustor based on measurements from a fuel temperature sensor, and
wherein the adjusting unit adjusts the fuel composition by controlling a blend of the fuel components of the fuel entering the combustor based on measurements from a fuel composition sensor through controlling the flows of one or more fuel components.

30. The controller of claim 29,
wherein the fuel composition sensor is a gas chromatography device, a Wobbe meter, or a calorimeter,
wherein the adjusting unit determines flammability indices of the fuel based on based on measurements from the gas chromatography device, by converting Wobbe indices of the fuel components measured by the Wobbe meter, or by converting heat values of the fuel components measured by the calorimeter, and
wherein the adjusting unit adjusts the blend of the fuel components based flammability indices of one or more individual fuel components.

31. The controller of claim 30, wherein the adjusting unit adjusts the fuel-to-air ratio of the mixture further by:
determining the fuel flow necessary maintain the flammability limit of the mixture at or above the desired combustible lean limit at a designed fuel operation temperature;
receiving from a fuel temperature sensor the fuel temperature of the fuel; and
determining when the fuel temperature is below the designed fuel operation temperature, an amount of additional fuel flow necessary to compensate for the lower temperature of the fuel so as to maintain the flammability at or above the desired combustible lean limit.

32. The controller of claim 19, wherein the adjusting unit adjusts the fuel-to-air ratio of the mixture by adjusting any one or more of air flow, air temperature, and air pressure based on the desired combustible lean limit.

33. The controller of claim 32,
wherein the adjusting unit adjusts the air flow by controlling a total amount of air entering the combustor through controlling one or more of an amount of air entering the combustor, an amount of returning air to an inlet of an air compressor, and an amount of air bypassing the combustor,
wherein the adjusting unit adjusts the air temperature by diverting at least a part of the air to a heat exchanger prior to the air part or entering the combustor based on measurements from an air temperature sensor, and
wherein the adjusting unit adjusts the air pressure by controlling delivery of compressed air from the compressor to the combustor.

34. The controller of claim 19, further comprising:
wherein the adjusting unit receives measurements from one or more flame sensors measuring one or more flame parameters of the flame in the combustor, and
wherein the adjusting unit adjusts the fuel-to-air ratio of the mixture entering the combustor based on measured parameters of the flame sensor.

35. The controller of claim 21, further comprising a fuel limit setting unit arranged to determine, when the gas turbine is in the acceleration mode of the gas turbine start up period, a minimum fuel setting with combustible lean limits correction and a maximum fuel setting with combustible rich limits correction.

36. The controller of claim 19, wherein the adjusting unit adjusts fuel-to-air ratio by:
determining an acceleration of a rotor of the gas turbine based on a rotor speed provided by a rotor speed sensor, and
adjusting the fuel-to-air ratio of the mixture further based on one or both of an amount of acceleration of the rotor and a comparison between lower heating value, flammability index of the fuel, and lean blow out of combustor flame.
